(19) United States
(12) Patent Application Publication
(10) Pub. No.: US 2005/0182737 A1
(43) Pub. Date: Aug. 18, 2005

(54) Process for media integration

(76) Inventor: Charles D. Brown, Woodinville, WA (US)

Correspondence Address: PATRICK M. DWYER PC, SUITE 114, 1818 WESTLAKE AVENUE N, SEATTLE, WA, 98109, US

(21) Appl. No.: 10/993,921

(22) Filed: Nov. 19, 2004

Related U.S. Application Data
(60) Provisional application No. 60/524,295, filed on Nov. 21, 2003.

(51) Int. Cl. G06F 17/60

(52) U.S. Cl. 705/80

(57) ABSTRACT

A method of repeat impression, multimedia, integrated messaging marketing attached to a collection of one or more community events on behalf of one or more event sponsors. The method may have one or more additional steps implemented before, during or after community events over a network of computers, cell phone systems, television and radio broadcast stations and at geographical sites.

### SURROUNDMEDIA™ INTRODUCTION

SurroundMedia™ is a unique process designed to serve marketing, sales and promotional needs of event sponsors. The SurroundMedia™ process integrates radio, television, an Internet website and in-person messaging at events to surround the event and its attendees.

### SURROUNDMEDIA™ PROCESS DESCRIPTION

The process begins in advance of the event, where radio and/or TV broadcast messages are transmitted to create awareness of the event and the sponsor of the message being broadcast. The broadcast message also motivates the listener to visit Festivals.com's website to learn more about the event and register to win a trip to an event by searching Festivals.com's database of upcoming events.

The broadcast also encourages the listener ti visit Festivals.com representatives at its booth at the event to receive promotional codes that can be entered on

Festivals.com's website to improve the registrant's opportunity to win the trip they have identified from searching Festivals.com's database of upcoming events. The promotional codes that are handed to the attendees by Festivals.com representatives are given to the attendees according to the different demographic categories identified by the Sponsor who has engaged Festivals.com to deploy the SurroundMedia™ sponsorship process. When the attendees are given the codes, they are encouraged to go to the website and enter the code to win the trip to an event they choose. After the attendees enter the codes that uniquely identify them by their demographic category, subsequent advertising messages that are presented as the attendees view the content on the website are specific to the demographic category identified by the code received at the event.

During the event, Festivals.com records the activity at the event which is used to create a television program. The TV program is aired from one to 8 weeks after the event. After the event has closed and prior to the airing of the TV program featuring the event, Festivals.com promotes the SurroundMedia™ sponsor and the TV program via TV and radio broadcast messages that also highlight the opportunity to win a trip by registering on the Festivals.com website and identifying events that the registrant would like to win a trip to from searching through the Festivals.com database of events. During this search process, the sponsors advertising messages are presented to the web attendees.

During the TV show, the winner(s) of the trip are announced, and the SurroundMedia™ sponsor(s) are highlighted as the provider of the trip to the event. Festivals.com delivers integrated promotion and sponsorship programs for producers and sponsors as a media sponsor Festivals.com promotes festivals and fairs via television and the Internet we develop national sponsorship by enhancing events with SurroundMedia promotional programs and provide backstage services that benefit an event's suppliers and provide additional revenue for the event.

For sponsors we deliver multimedia repeat impressions sponsorship programs by surround the event with television and promotion tied to the Festivals.com website to attract national sponsorship where nice individual festivals and fairs into planned communities treated with SurroundMedia™ programs.

We work with festival in your producers in advance of the event to identify key aspects to be highlighted during the TV show and record the color pageantry and excitement as communities celebrate.

The Festivals.com website is synchronized to promote the event and its key sponsors and suppliers promotional programs dry consumers to the website where they learn more about the event and apply to entry trip to festivals generating substantial impressions for the event and SurroundMedia™ sponsor's the promotional programs begin seven to 10 days before the event to dry the tenants and initiate the sponsors campaign optional in person on-site messaging activation may be deployed during the event for SurroundMedia™ sponsor is by Festivals.com further stimulating web traffic and television viewership.

After the event promotion continues attracting attendees and others to the website where that may enter special code to receive during the event continue searching for a festival they would like to win a trip to our vote in response to a promotional campaign.

Approximately three weeks after the event the television program is there a channel selected to correspond with the SurroundMedia sponsor's demographic objectives the other event sponsors and suppliers also have an opportunity to participate in the television sponsorship.

After the program the festival and SurroundMedia sponsor have an opportunity to send thank you e-mails to website visitors who are registered for the promotional programs.

Normally promotion stops at the close of the event with SurroundMedia the consumer in the event are surrounded by multimedia repeat impression promotion that extends and enhances traditional programs the result is a significant increase in the number impressions provided to SurroundMedia sponsors and the event to attract national sponsors individual events treat it with SurroundMedia were organized into planned communities based on the sponsors reach geographic demographic and impression depth objectives planned communities require no effort on the part of the individual event partners and represent opportunity to deliver new sources of revenue to our festival in fair relationships.

In addition to our SurroundMedia sponsorship programs Festivals.com works with events to market its backstage services to the event spenders and suppliers these backstage services provide the vendor with a full-page listing on the Festivals.com website advertising to consumers product listings the pictures contact information for consumers and a link to the suppliers website if they have won most importantly the event overhang the benefit of linking vendors and suppliers registered on the backstage to the event's Festivals.com web page this provides a way for the customer to find vendors after the closing giving the event and its merchants a greater sense of permanence during 2004 Festivals.com will also asked be expanding its backstage services to provide jury selection services for events to reduce administrative or

Festivals.com is organized its SurroundMedia sponsor program to deliver broadcast TV promotion national sponsorship sales support and supply revenue with minimal effort to the eventand@nochargeFestivals.com benefits through commissions from the sale of event sponsorship packages sold with SurroundMedia programs and revenue from supply registrations on our backstage as a result we succeed when you succeed together.

### SUMMARY OF SPONSOR SERVICES AND BENEFITS

Festivals.com helps sponsors efficiently market to consumes at festivals, fairs and community events. We offer two turn-key services including organizing sponsorable networks of festivals: our Planned Community™ development service; and SurroundMedia™ activation campaigns—multimedia programs that integrate On-air, On-line and On-ground™ media using our TV programs, website, and in-person messaging. Our festival sponsorship and activation services may be contracted for individually or in combination. When deployed together our unique media position and extensive festival relationships allow us deliver half hour branded entertainment TV shows linked with interactive web programs to significantly extend the value of the activation programs from within existing budget.

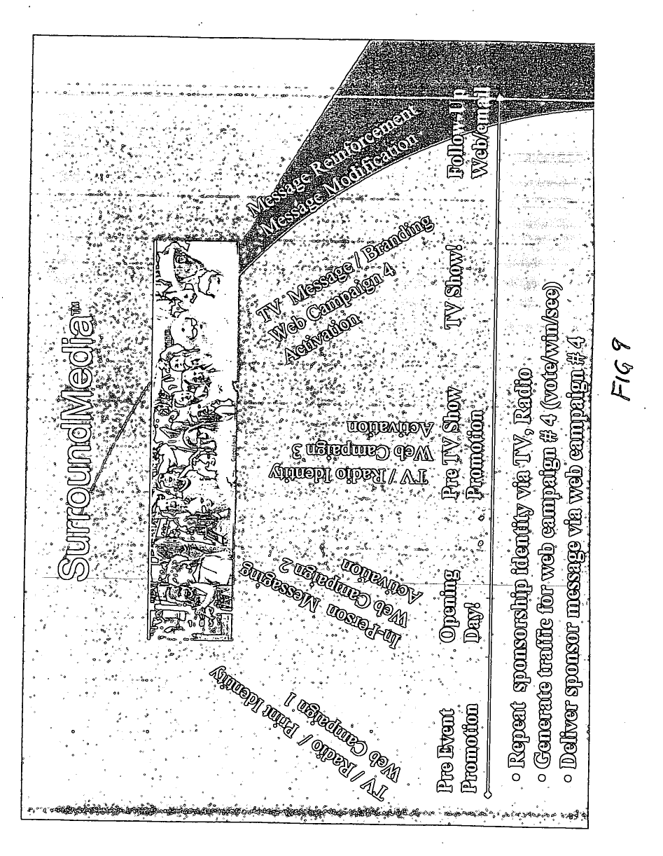

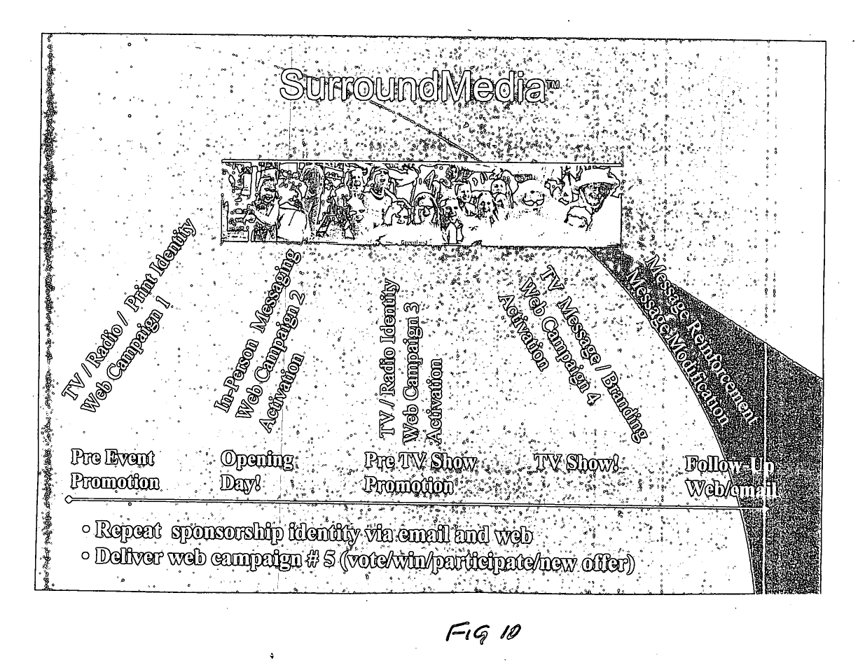

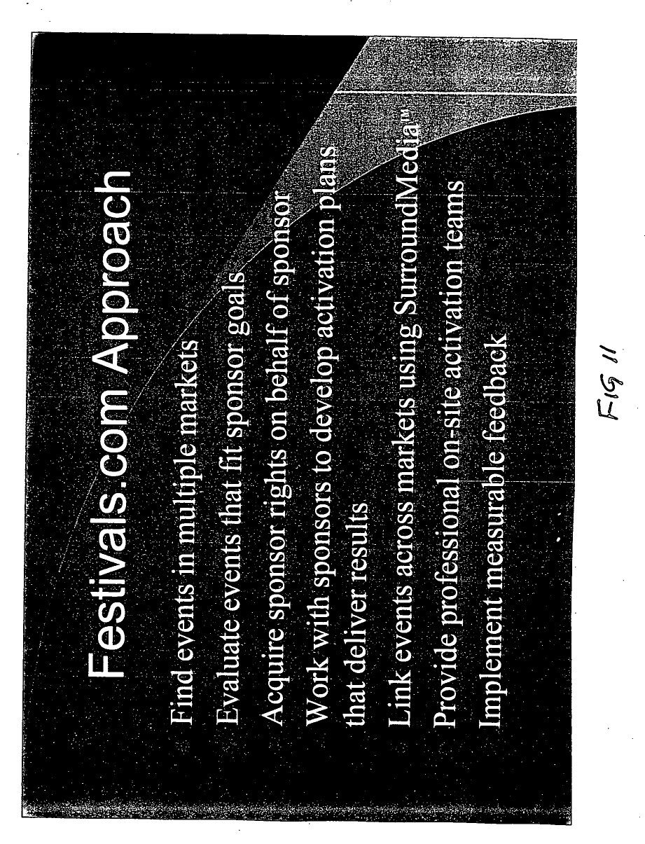

Planned Community™ Development Services: We organize sponsorable networks of events we refer to as Planned Communities™. Events are selected according to your demographic geographic, consumer reach, activation and budget requirements. We negotiate, purchase and deliver sponsorship rights on your behalf providing efficient access and broad consumer reach. See FIGS. 20a and 20b; where the random circle/dot objects of FIG. 20a represent individual events in an historic sponsorship profile with events sponsored without coordinated demographics, theme and activation; and where the connected circles represent the same events, but in the context of a SurroundMedia Planned Community, where the festivals or events are organized by demographics, geography, theme, rights and activation programs.

Benefits Include:

Consumer Reach: Festivals.com has relationships with tens of thoughts of events that attract more than 200 million consumers each year. We have collected information about events since 1995 and use the information to organize efficient turn-key consumer access.

Strategic Event Focus: Because of our unique database we are able to identify events that attract your target demographics. We use this information to maximize your “effective reach” and to organize a framework for systematic development of target markets.

Time, Resources and Money: We save you time by finding events for you and presenting you optional events to sponsor. Once you have approved the events you want, we save your resources by negotiating the rights on your behalf to provide you efficient access to an inefficient industry. We save your money with effective negotiations and placements fees.

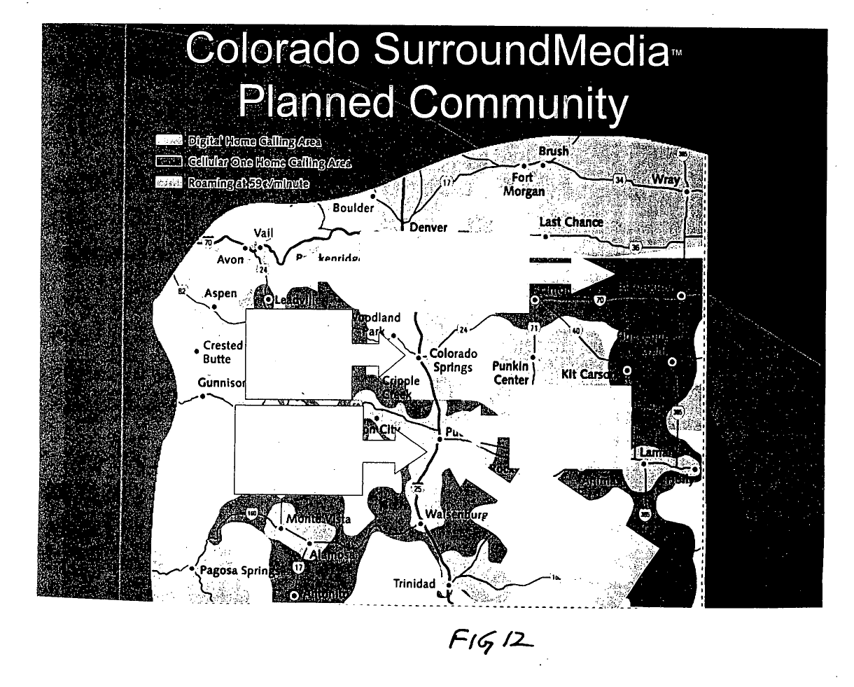

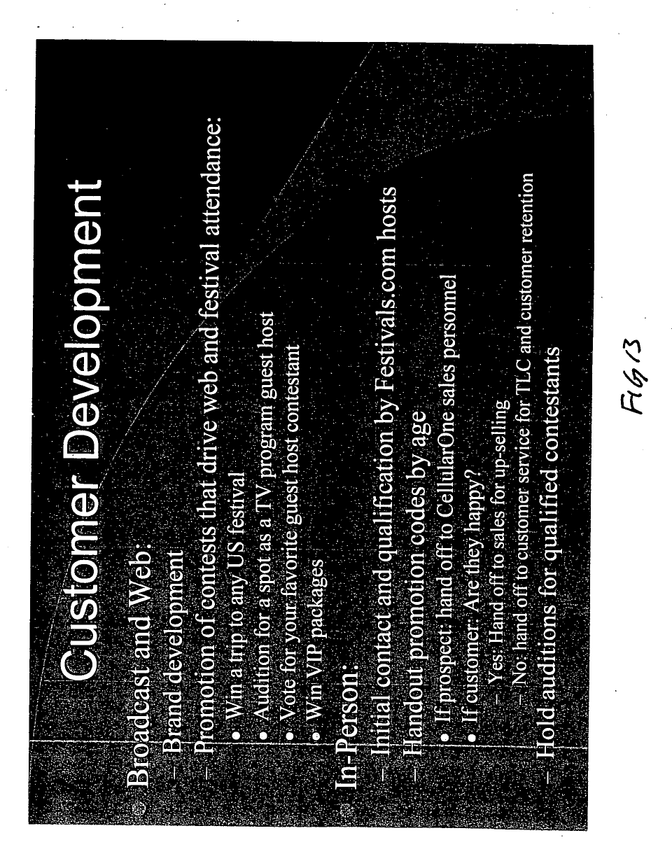

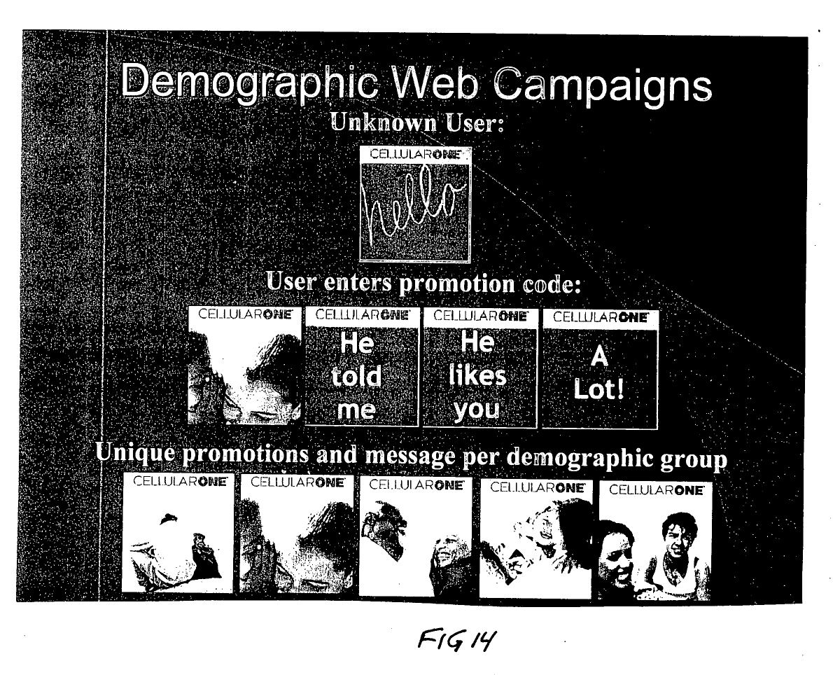

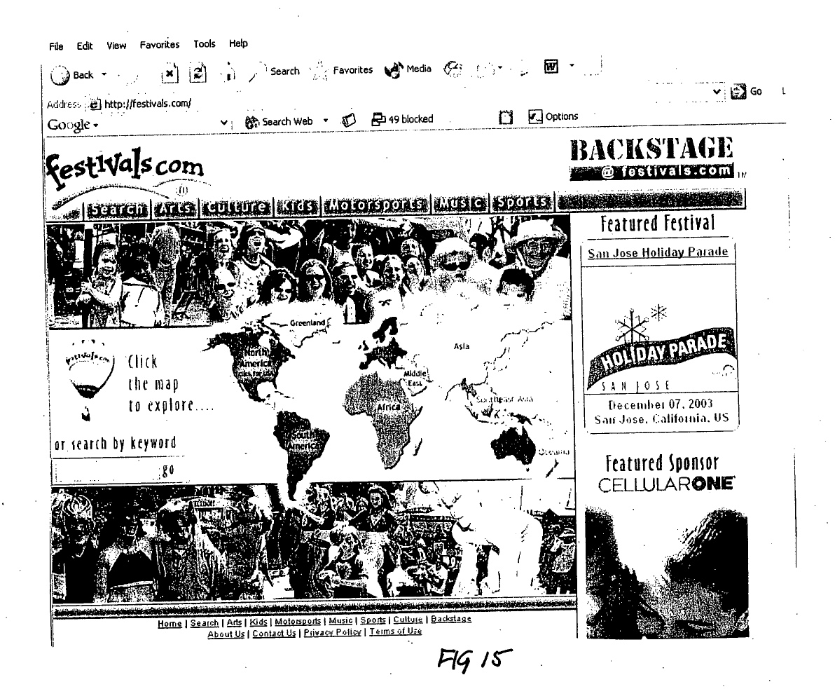

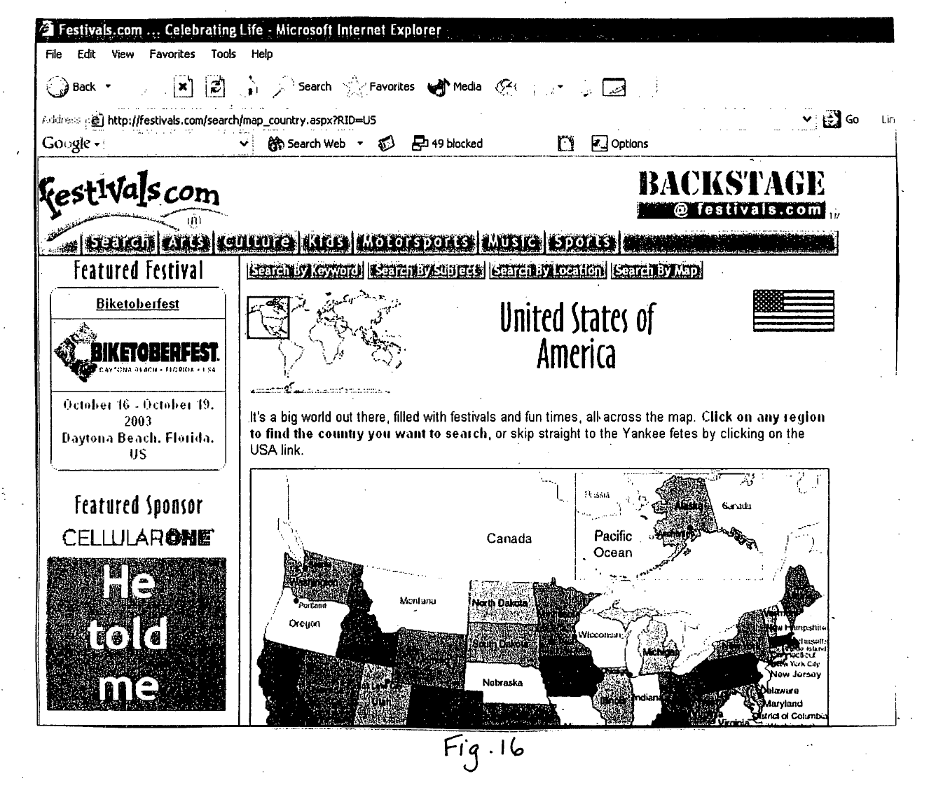

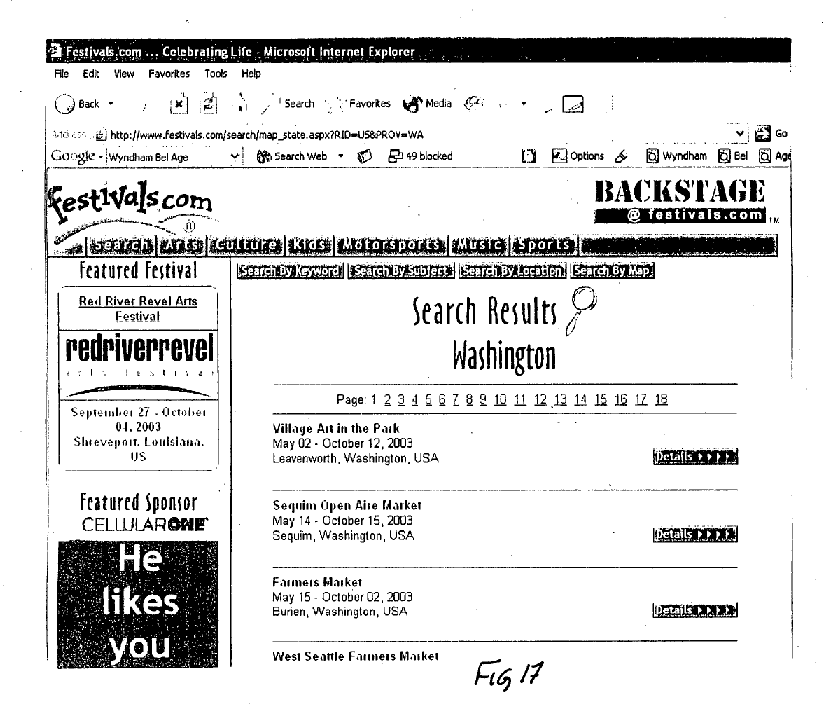

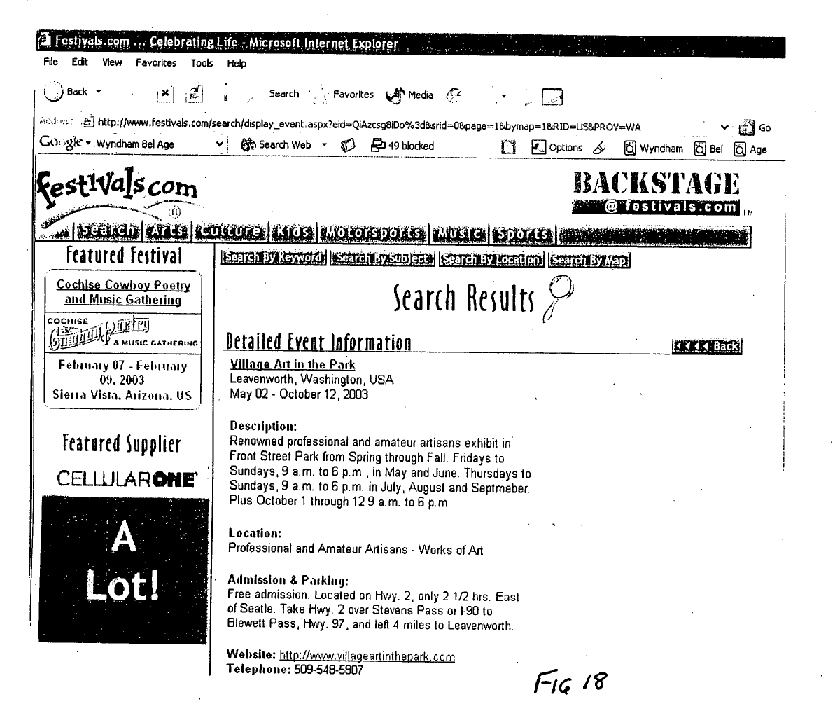

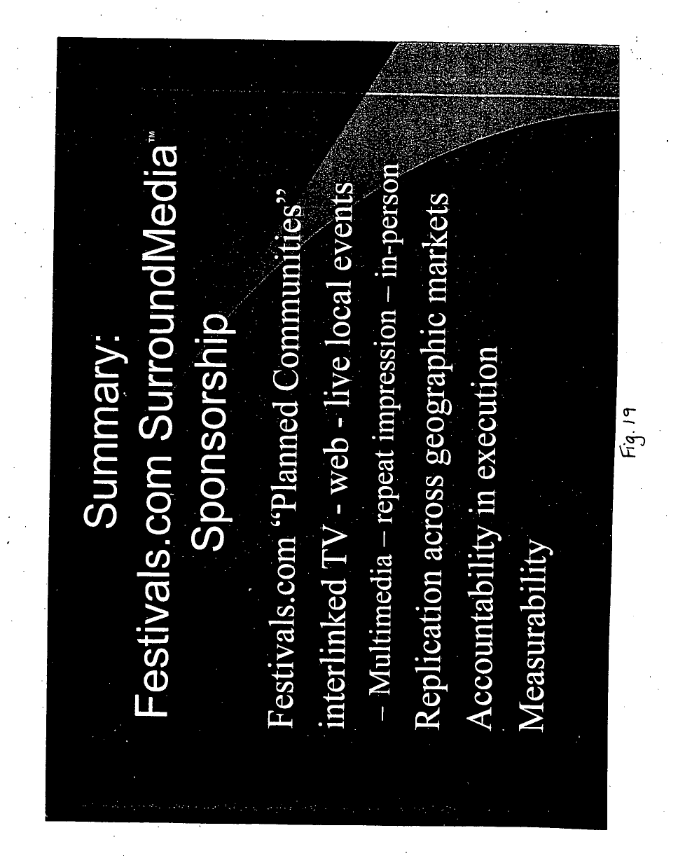

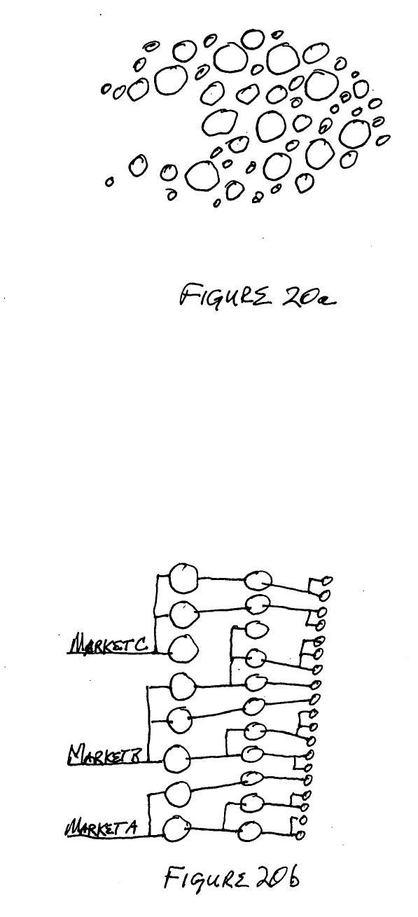

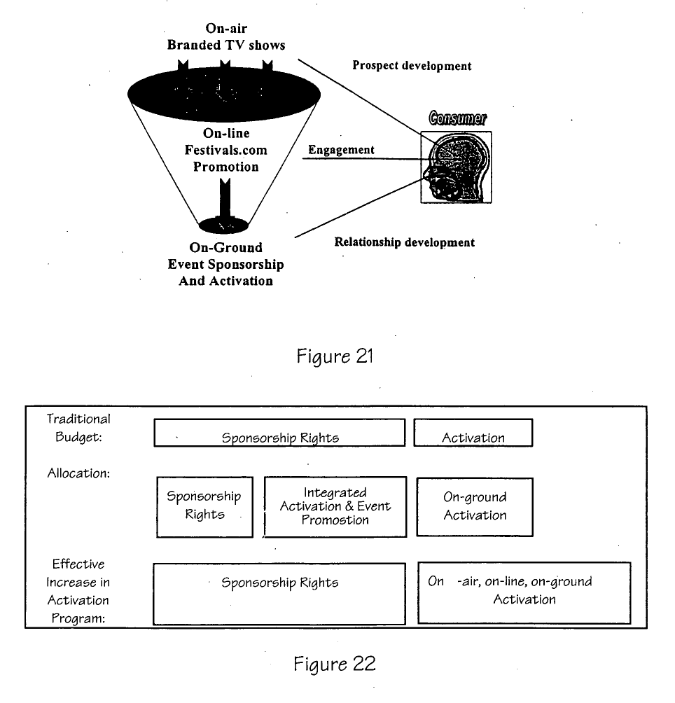

SurroundMedia™ Activation Services: We offer multimedia activation programs that integrate On-air, On-line and On-ground™ media using our programs, website, and in-person messages: See FIG. 21 illustrating SurroundMedia Activation.

Benefits Include:

Turn-key Activation: Our SurroundMedia™ activation programs maximize the value of your sponsorship investment by deploying an integrated multimedia campaign organized into a custom sales funnel. SurroundMedia™ campaigns include On-air branded entertainment TV programs to boost activation, On-line elements that engage prospects and build impression depth and On-ground activation campaigns that leverage the On-air and On-line results to create more relationships.

Auditing and Reporting: Festivals.com activation programs are designed to incorporate measurement and reporting. While performing activation, we are also positioned to audit and report on the sponsored events attendance, rights fulfillment and demographic value. This information allows us to implement quality control metrics for improvements in program performance over time

Integrated Planned Community™ and SurroundMedia™ Services

By combining our services you can obtain a substantial increase in benefits for the same budget. Festivals.com negotiates with festivals during the Planned Community™ development process to exchange branded entertainment TV shows and web content featuring the sponsored festivals in exchange for sponsorship rights. Festivals.com media benefits events by increasing attendance, elevating the value of their other sponsorship inventors, providing the events new sponsorship marketing materials and creating destination status. Our media simultaneously initiates your activation campaign with branded entertainment TV shows and web promotion that increases the effective benefits of your budget and your activation results. See FIG. 22 illustrating a resulting increase in activation program value.

Benefits of Integrated SurroundMedia™ Planned Community™Services:

Strategic market development with optimized turn-key activation

A framework for systematic penetration of targeted markets over time

Unique multimedia activation campaigns that incorporate half hour branded entertainment TV programs featuring the festivals and your activation campaign without an increase in your budget

Use of the Festivals.com website and customer base to engage more prospects

Auditing and reporting that facilitates continuous program improvement

Freed-up human resources for other objectives

A dynamic increase in the activation benefits for the same budget.

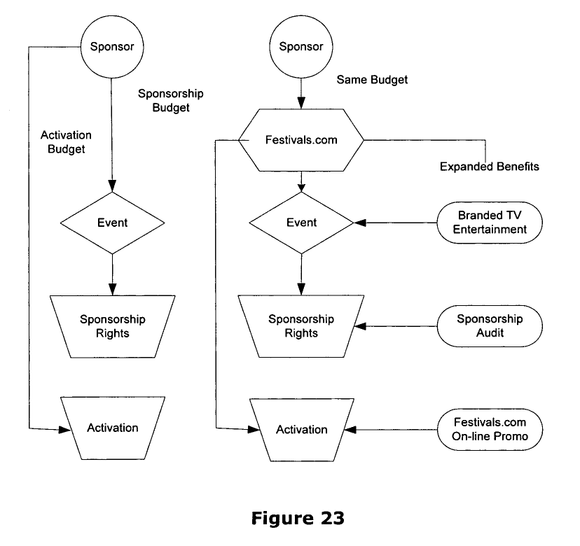

See FIG. 23 illustrating a maximized return on investment (ROI), where the left column represents traditional sponsorship, and the right column represents a SurroundMedia Planned Community.

About Festivals.com: Festivals.com is a media and entertainment company, helping sponsors efficiently market to consumers at fairs and festivals. Our motto is “Celebrate Life!”. Our media allows Festivals.com to offer unique value at the intersection where sponsors, events and consumers come together. We've developed media relationships with more than 43,000 festivals and events with a combined consumer reach that exceeds 200 million in the U.S. and 384 million globally. Our Festivals.com website serves millions of customers annually and is the largest internet resource for consumers to find festivals and events. Festivals.com produces TV shows featuring festivals around the country that air on major networks such as Universal Paramount Network (UPN). We also supply festival information to leading information and media companies. Some of our customers include Cendant Corporation (Avis, Budget Century 21, Ramada, Days Inn), SBC SMARTpages, The Food TV Network, Amtrak and DDB.

Festivals.com presented its capabilities to develop a unique festival and event based multimedia-repeat impression-in person marketing campaign designed to generate significant brand awareness and stimulate sales. This proposal provides a description of the deployment strategy, the program objectives.

Festivals.com was founded in 1995 and today is the largest consumer resource on the Internet for information about community festivals, fairs and special events. Producers have populated the Festivals.com database with more than 40,000 festivals and events. As a result, Festivals.com operates the most popular and widely used festivals website on the Internet. Festivals.com sits atop all of the leading Internet search engines, and information providers including The LA Times, SBC Smartpages, AOL, MSN and CNN link to or source information from Festivals.com.

In 2003 Festivals.com aired its first TV program designed to enhance its consumer offerings, and launched a state-of-art web platform as part of an innovative sponsorship service that incorporates a new patent pending strategic marketing process called SurroundMedia™. This new sponsorship service is designed for corporations seeking to link marketing, sales, promotion and branding efforts into a strategically integrated multimedia repeat impression marketing program.

About SurroundMedia™ Planned Communities

The SurroundMedia™ process is a unique integration of mass media promotion, Internet messaging, on-site festival sales activation and half hour TV show programming content, which surrounds both the festival and consumer. The process transforms an individual festival or event into a 4 to 6 week sponsorship campaign that engages the consumer with a process to simultaneously build brand, qualify prospects, convert prospects to customers, and support customer service.

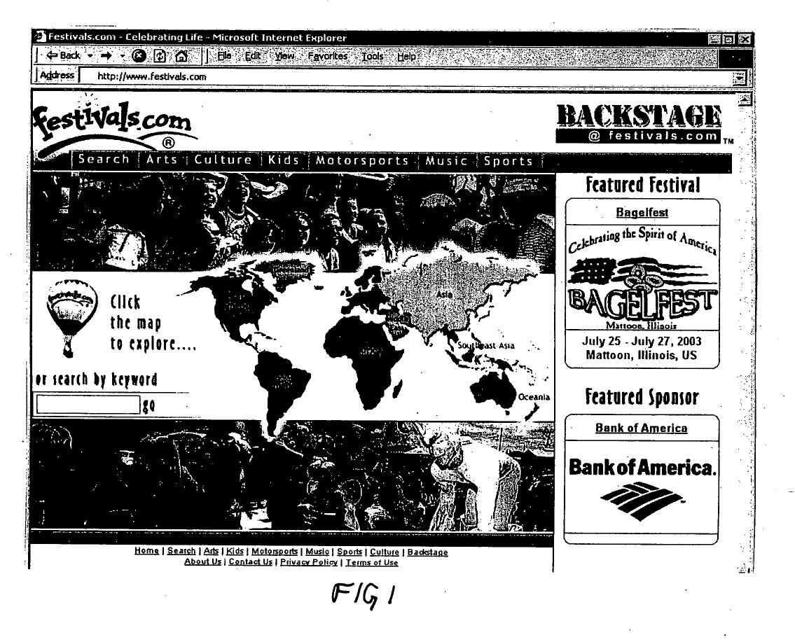

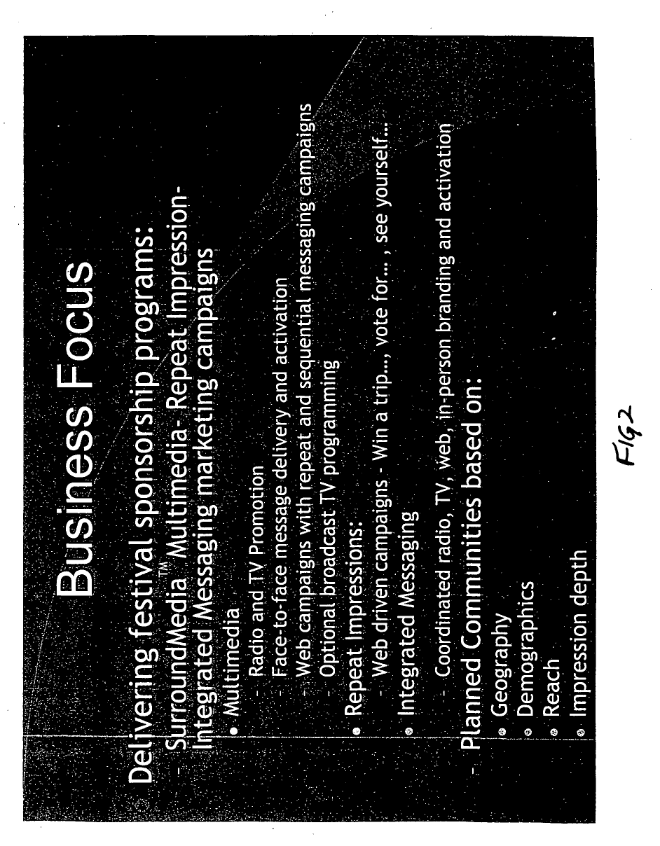

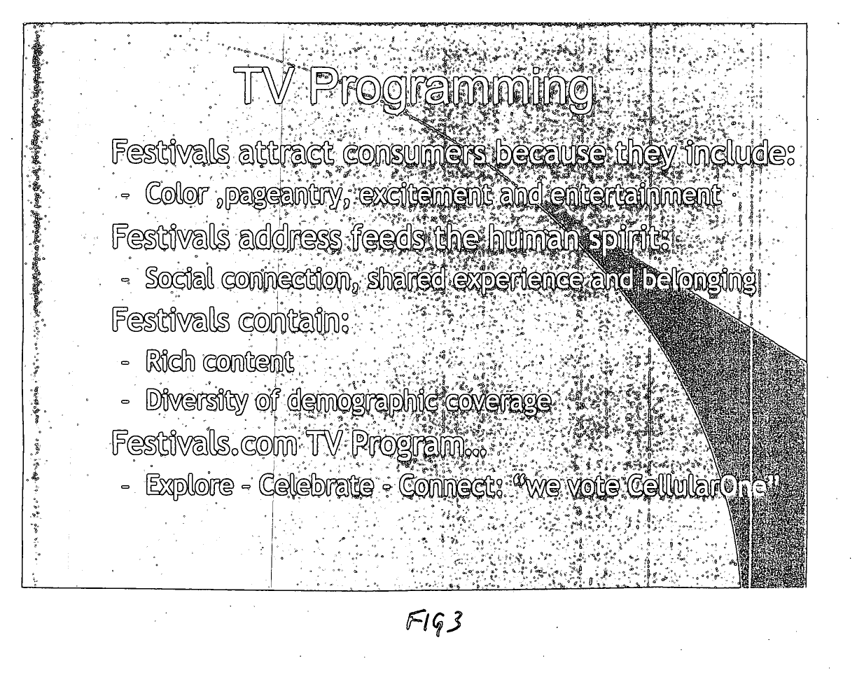

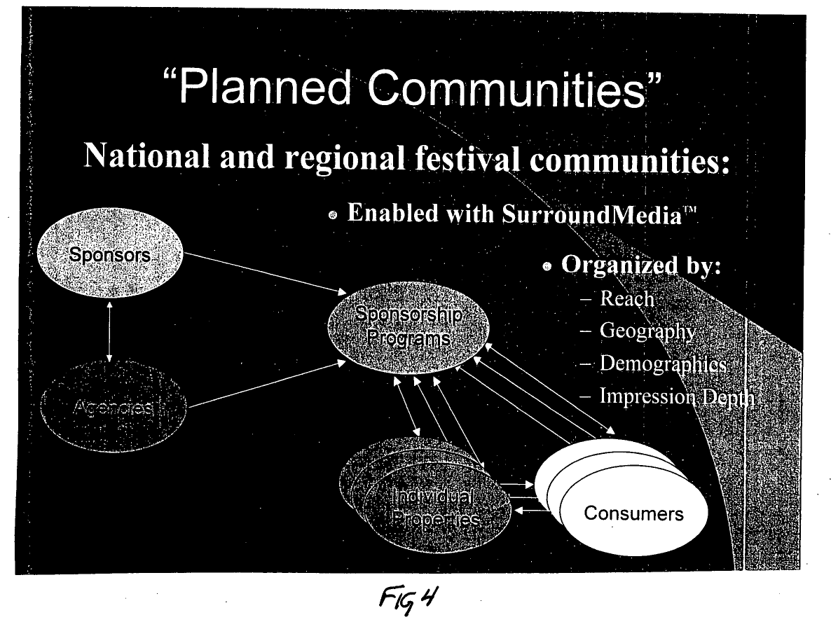

Planned Communities are collections of festivals and events, treated with SurroundMedia™ that are chosen to meet a sponsor's reach, geographic, demographic and impression depth objectives across markets over time. SurroundMedia™ Planned Communities turn a single, local marketing project into a strategic marketing program that provides deep brand-building exposure, delivers qualified consumer prospects, and provides measurable results for marketing management. See FIG. 5 illustrating how SurroundMedia turns a single event into a multimedia repeat impression marketing campaign.

CellularOne SurroundMedia™ Planned Community Pilot Program

The Colorado market was identified by CellularOne as a viable market for a pilot since it has good digital signal distribution and a reasonable population base of approximately 190,000. Festivals.com has analyzed he Colorado market and found it to be geographically challenging due to incongruent cell coverage. While this presents a minor challenge, we have been able to construct a SurroundMedia™ Planned Community program to provide repeat broadcast impressions across the entire addressable market, attract a sizable subset of the market to its website, deliver 171,475 in-person impressions and deliver 9,000 prospects to CellularOne sales personnel. Specifically the pilot program seeks to achieve the following objectives:
Target young adults 20 to 34, and teens 12 to 18 drawing in their parents 35 to 55
Build a CellularOne community via a structured SurroundMedia™ TV treatment
Give CellularOne—a human face within the community
Drive “In-Person” contact to qualify prospects
Reach the total market of 606,400 (DMA) with 9.3 million broadcast impressions from April through September 2004
Deliver 7.4 million web impressions over the same period
Deliver 171,475 in-person messages to prospects
Deliver 9,130 qualified prospects
Achieve a program cost per customer of $45 to $65
   SurroundMedia™ Planned Community Program Description

Festivals.com has identified four festivals that attract 775,000 attendees, and constructed SurroundMedia™ treatments for those festivals. Because of the large number of rural towns in the Colorado market Festivals.com has also constructed a Chamber of Commerce tour to reach out to 22 towns. A summary of the target festivals, their reach, deployment dates and treatment status is provided below.

| Festival | Attendance | Month | TV Treatment |
|---|---|---|---|
| Chamber of Comm. Tours | 40,000 | April to May | Yes |
| Bluegrass on the River | 5,000 | June | Yes |
| Colorado State Fair | 710,000 | August | Yes |
| Chile & Frijoles Festival | 20,000 | September | Yes |
| Totals | 775,000 | | |

Sponsorship Levels

Each of the festivals will feature CellularOne as either the lead or a prominent sponsor of the event depending on budget and availability. CellularOne will be the title sponsor for all of the Festivals.com “World of Festivals” SurroundMedia™ half hour TV programs. CellularOne will be identified in radio, television and print broadcasting as well as on Festivals.com's website. The television and radio broadcasting will present brand building impressions to prospective customers and drive them to the web where additional impressions will be delivered and to a booth at the festival for in-person selling.

Promotional Giveaways

Promotional giveaways targeted at different demographic groups will be offered during the broadcast promotions including a free trip to a festival anywhere within United States, and the opportunity to become a guest host on one of Festivals.com's television programs. Customer prospects will also have an opportunity to vote by phone and on the web for a their favorite guest host candidates.

Promotional Activities:

Phones: Consumers who win online promotions will receive celebrity-signed promotional cell phones.
VIP Treatment: Consumers can win VIP participation in an upcoming festival
Free Trips: Consumers who win the major sweepstakes associated with the campaign will receive a trip for 2 to a festival of their choice anywhere in the US.
Vote For: Go to the web or vote by phone for your favorite guest host candidate; contestants introduce themselves on the show and ask viewers to vote for them.
   Chamber of Commerce Tour

The Chamber of Commerce tour is designed to develop a sense of community around the CellularOne brand. Conducted jointly by a Cellular One public relations and Festivals.com team, the tour will engage the small communities in the Colorado market. Specifically, at organized events large groups of attendees will be filmed while chanting “hello from town X” and “we vote CellularOne”, which will be played in other Chamber of Commerce organized events. These activities will be integrated with the guest host auditions. Web and text message voting will go on during the course of the planned community activity to maintain contact with the customers. It is expected that a subset of the prospects will not have Internet access and an effort will be made to identify resources within the towns including libraries and school resources that are accessible to the general public.

Pre-Festival Web Impressions and Branding

The CellularOne and Festivals.com websites are an integral part of the promotional campaign. Broadcast radio and television promotional spots will be designed to drive consumers to the CellularOne and Festivals.com websites and to the festivals to participate in the promotional giveaways, voting, and guest host auditions.

Festival Sales and Customer Service

As Festivals.com personnel greet individuals at the festivals, they will qualify them as either existing CellularOne customers, viable prospects or those outside of CellularOne coverage. Existing CellularOne customers will be further qualified as either satisfied or unsatisfied. CellularOne will operate two distinct separately located booths at each event where sales prospects and unhappy customers will be directed by Festivals.com personnel. CellularOne sales personnel will receive highly qualified prospects, which should result in a high customer signup rate, depending on the quality of the offer. Even if the prospects do not sign up at the tent, the process of showing them optional phones and collecting information about their phone preferences will enable subsequent conversion to customer status via web offers. Meanwhile, unhappy customers can be services with TLC for retention at a separate tent.

Post Festival—Pre-TV Show Web Impressions and Branding

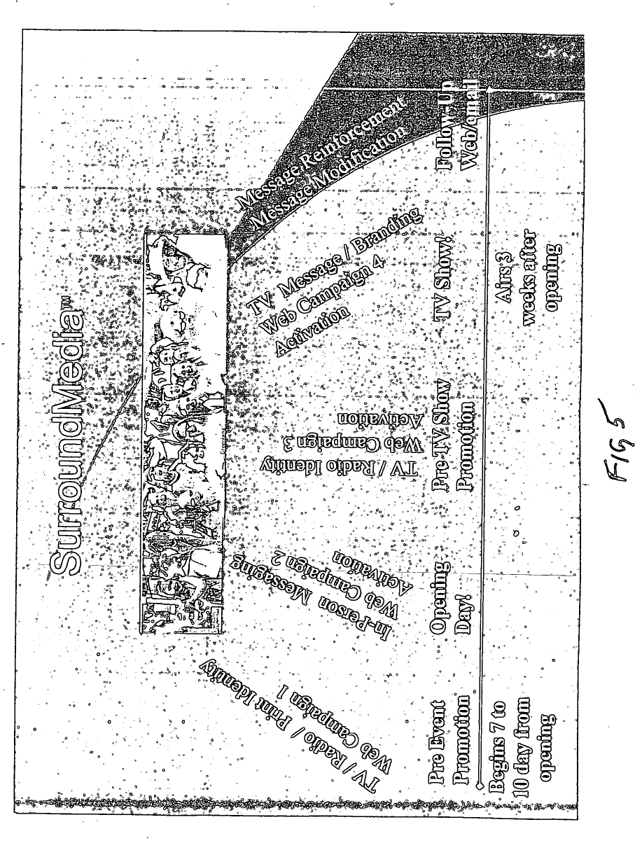

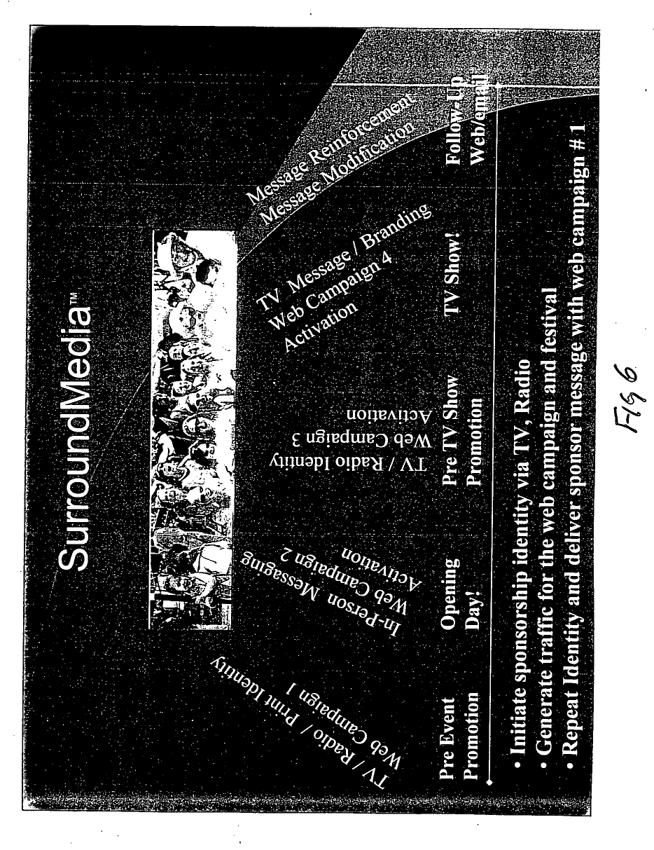

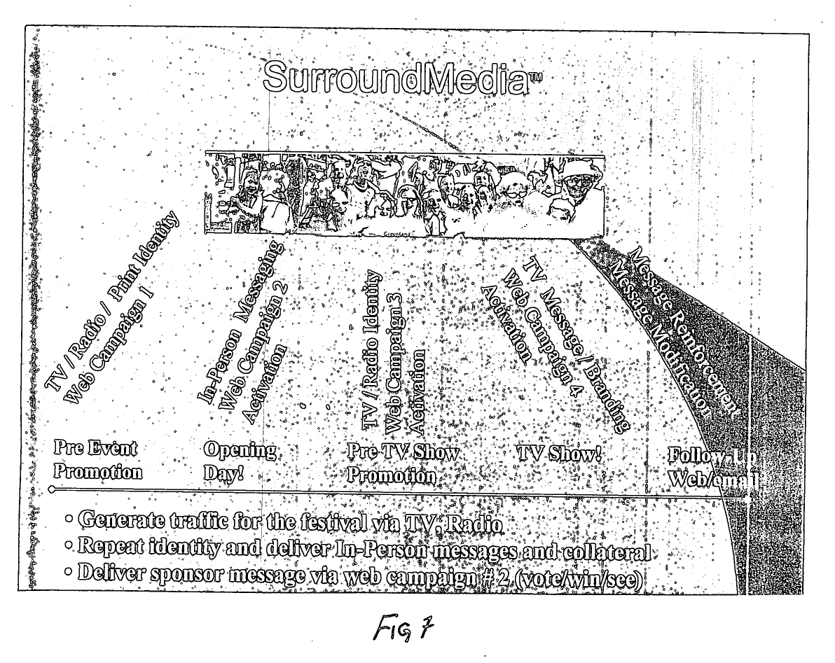

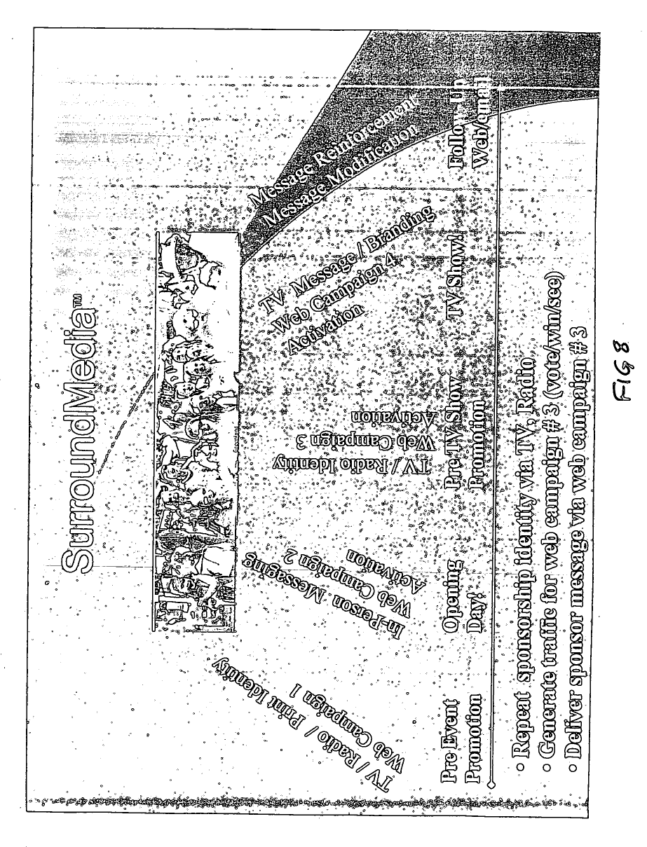

During the qualification process, Festivals.com or CellularOne personnel will provide promotional codes to be entered into the Festivals.com web site. The promotional codes will be provided according to demographic profiles so that when individuals enter the promotional codes, subsequent web impressions are specific to their demographic profile, and even telephone preference. The free trip promotion is a particularly powerful way to deliver significant profile specific brand building repeat impression campaigns to prospective customers because of the tendency to look at tends of festivals during their selection process. The web users can be further qualified as existing or prospective customers. Existing customers can be targeted for purchasing additional features, while new prospects are motivated towards initial signup. Each group can receive customized Web campaigns which can optionally include sequential messaging. See FIG. 14 illustrating how festivals.com website can deliver sequential or repetitive campaigns based on demographic profile.

Brand Development and Sales Objectives

A detailed program implementation plan has been developed which incorporates a number of decisions regarding the amount of broadcast promotion, web and email campaigns, the number of SurroundMedia™ TV programs to be aired, and the ground resources deployed at each of the events. The decisions on the budgetary resources allocated for each of these activities drive the projected results. The results, which are measured in terms of brand impressions and target new customers are summarized below.

It is important to note that the projections below have been organized without the benefit of input from CellularOne, particularly with regard to the amount of budgetary resources allocated to each of these activities, and the sales closure rate. It is assumed that the key assumptions including sales closure rate, which is a function of the offer provided to the prospects, will be reviewed, agreed upon, and then used as key management metrics for he program performance analysis. Additionally, this program does not yet, but should, attempt to stimulate and measure the up-sale potential from existing customers.

Program Brand Development and Performance Objectives
Impression Depth Alternatives

| | High | Medium | Low | Very Low |
|---|---|---|---|---|
| Pre Event Radio | 30 | 20 | 10 | 5 |
| Pre Event TV | 12 | 9 | 6 | 3 |
| Handouts | 20% | 18% | 16% | 14% |
| In-Person Message Delivery | 10.0% | 9.0% | 8.0% | 7.0% |
| Event Radio | 20 | 15 | 10 | 5 |
| Event TV | 6 | 4 | 2 | 1 |
| Pre-TV Radio | 30 | 20 | 10 | 5 |
| Pre-TV TV | 12 | 9 | 6 | 3 |
| TV Show | 4 | 4 | 4 | 4 |
| Web Flow Through Fest. 1 | 9.0% | 6.3% | 4.4% | 3.1% |
| Web Flow Through Fest. 2 | 8.0% | 5.6% | 3.9% | 2.7% |
| Web Flow Through Fest. 3 | 7.0% | 4.9% | 3.4% | 2.4% |
| Web Flow Through Fest. 4 | 6.5% | 4.6% | 3.2% | 2.2% |
| Direct Sales Close Rate | 0.95% | 0.86% | 0.77% | 0.69% |
| Web Sales Close Rate | 0.95% | 0.86% | 0.77% | 0.69% |
| Total Radio Spots | 320 | 245 | 170 | 125 |
| Total TV Spots | 152 | 128 | 104 | 83 |
| Impressions per Radio Spot | 6,100 | 6,100 | 6,100 | 6,100 |
| Impressions per TV Spot | 48,800 | 48,800 | 48,800 | 48,800 |
| Radio Impressions | 1,952,000 | 1,494,500 | 1,037,000 | 762,500 |
| TV Impressions | 7,417,600 | 6,246,400 | 5,075,200 | 4,050,400 |
| Total Broadcast Impressions | 9,369,600 | 7,740,900 | 6,112,200 | 4,812,900 |
| Impressions Depth Per | 15 | 13 | 10 | 8 |
| Prospect | | | | |
| Unique Impressions (DMA | 610,000 | 610,000 | 610,000 | 610,000 |
| Based) | | | | |
| Web flow through rate | 0 | 0 | 0 | 0 |
| Web prospects (non-unique) | 186,050 | 130,235 | 91,165 | 63,815 |
| Web Campaign Depth Per | 3 | 3 | 3 | 3 |
| Prospect | | | | |
| Web Impressions Per | 8 | 8 | 8 | 8 |
| Campaign | | | | |
| Web Impressions Per Prospect | 32 | 32 | 32 | 32 |
| Total Web Impressions | 7,442,000 | 5,209,400 | 3,646,580 | 2,552,606 |
| In-Person Impressions | 171,475 | 153,506 | 135,839 | 118,474 |
| Total Impressions (all forms) | 16,983,075 | 13,103,806 | 9,894,619 | 7,483,980 |
| Customer Development: | | | | |
| Festival Attendance | 775,000 | 775,000 | 775,000 | 775,000 |
| Lead Development Rate | 0.95% | 0.86% | 0.77% | 0.69% |
| New Direct Sales Prospects | 7,363 | 6,626 | 5,964 | 5,367 |
| Web Viewership | 186,050 | 130,235 | 91,165 | 63,815 |
| Lead Development Rate | 0.95% | 0.86% | 0.77% | 0.69% |
| New Web prospects | 1,767 | 1,114 | 702 | 442 |

It is important to note that the structure defined for the pilot is subject to significant modification. CellularOne may elect to implement only one festival or significantly reduce the radio and/or TV broadcasting as reflected in the impression depth analysis. Additionally, Cellular One may elect to redirect Festivals.com to focus on another geographical market. The “High” budget presents an aggressive brand satisfaction treatment for the Colorado, following by lessening impression depth rates.

At the request of CellularOne, Festivals.com has developed a proposed pilot SurroundMedia™ Planned Community, designed to strategically build brand, acquire new customers, up-sell existing customers, and deliver customer service through single integrated marketing campaign. The elements within this pilot program are subject to review and modification including the number of festivals, the number of SurroundMedia™ television programs, and the impression depth, which affect total cost and sales closure rate. The impression depth and sales closure rates should be measured and adjusted through the process to determine the optimal balance between program expenditures, brand building and customer development. The pricing above assumes the high promotion rate.

1. A method of repeat impression, multimedia, integrated messaging marketing attached to a collection of one or more community events on behalf of one or more event sponsors, the method comprising at least one of the following steps implemented before, during or after community events over a network of computers, cell phone systems, television and radio broadcast stations and at geographical sites:
a. negotiating sponsorship terms on behalf of one or more event sponsors
b. broadcasting marketing content prior or during the event(s) on at least television station or radio station, or through in person contact at a geographical location, directing event prospects to event attendance or directing prospects to display of promotional materials on at least one computer
c. collecting, via a network of computers, profile data on prospects
d. making in person contact during the event(s) at the event location directing prospects to one or more sponsor sites at the event
e. making in person contact during the event(s) distributing materials motivating prospects to participation in post event promotions or directing prospects to display on at least one computer of promotional materials
f. making in person contact during the event(s) collecting profile data on prospects
g. broadcasting on at least one television station after the event(s) a showcase of event participation with promotional material and directing viewers to participation in post event promotions or directing prospects to display on at least one computer of promotional materials
h. broadcasting on at least one radio station or making in person contact after the event(s) directing prospects to participate in post event promotions or watch a television broadcast of event participation with promotional material
i. emailing, Internet messaging or text messaging via cell phone, message sequences to prospects after the event directing prospects to attend another event, participate in post event promotions or view promotional materials on at least one computer
j. a method of measurement and reporting to audit and report on the sponsored event(s) attendance, rights fulfillment and demographic value
